(19) United States
(12) Patent Application Publication
(10) Pub. No.: US 2011/0125316 A1
(43) Pub. Date: May 26, 2011

(54) UNIVERSAL BILL RECYCLER

(75) Inventors: Craig Lewis, Berwyn, PA (US); Anton Rakushkin, Sharon, MA (US); Viktor Rogachov, Toronto (CA); Scott Hudis, Stillwater, MN (US)

(73) Assignee: CRANE MERCHANDISING SYSTEMS, INC., Bridgeton, MO (US)

(21) Appl. No.: 12/887,319

(22) Filed: Sep. 21, 2010

Related U.S. Application Data
(63) Continuation-in-part of application No. 12/579,266, filed on Oct. 14, 2009.
(60) Provisional application No. 61/196,017, filed on Oct. 14, 2008.
(60) Provisional application No. 61/244,858, filed on Sep. 22, 2009.

(51) Int. Cl. G06F 17/00; G07F 7/04

(52) U.S. Cl. 700/232; 194/206

(57) ABSTRACT

A bill recycler accepts bills and payment and dispenses previously accepted bills as change in a vending machine including a vending machine controller and a coin handler. The bill recycler receives from the coin handler information relating to denomination(s) and quantities of coins available for dispensing by the coin handler, alters that information to include information relating to quantities of denomination(s) of bills available for dispensing by the bill recycler, then sends the altered information to the vending machine controller.

### CROSS-REFERENCE TO OTHER APPLICATIONS

This application is a continuation-in-part of commonly assigned, co-pending U.S. patent application Ser. No. 12/579,266, filed Oct. 14, 2009, and through that application claims the benefit of the filing date of U.S. Provisional Patent Application Ser. No. 61/196,017 filed Oct. 14, 2008. This application also claims the benefit of the filing date of U.S. Provisional Patent Application Ser. No. 61/244,858, filed Sep. 22, 2009. Each of the above-identified patent documents is hereby incorporated by reference.

### TECHNICAL FIELD

The present disclosure is directed, in general, to bill handling mechanisms and, more particularly, to systems and methods for recycling bills in vending machines.

### BACKGROUND OF THE DISCLOSURE

Vending machines accept bills and coins for making purchases of various beverages, snacks, foods, cigarettes, and other products. A vending machine is typically an unattended point of sale and is typically required to dispense change in order to permit flexibility in the cash that may be accepted as payment and in the pricing of products being vended. Typically, vending machines accept either bills or coins and dispense change in coins. When a large amount of change is to be dispensed, however, consumers may prefer to receive bills as change, rather than a “handful” of coins.

### SUMMARY OF THE DISCLOSURE

In one embodiment, a method of dispensing bills as change in a vending machine includes receiving in a bill recycler a first message. The first message is intended for a first device and includes first information. The first information relates to denomination(s) and quantities of coins available for dispensing by the coin handler. The method also includes altering the first information in the bill recycler to include information relating to quantities of denomination(s) of bills available for dispensing by the bill recycler. The method further includes sending the altered first information to the first device.

In another embodiment, bill recycler for use in a vending machine includes a controller and a bill recycling mechanism. The controller is adapted to receive a first message, which is intended for a first device and includes first information. The first information relates to denomination(s) and quantities of coins available for dispensing by the coin handler. The controller is also adapted to alter the first information to include information relating to quantities of denomination(s) of bills available for dispensing by the bill recycling mechanism. The controller is further adapted to send the altered first information to the intended recipient.

In still another embodiment, a vending machine includes a vending machine controller, a bill recycler, and a coin handler. The bill recycler is adapted to receive from the coin handler a first message, which includes first information. The first information relates to denomination(s) and quantities of coins available for dispensing by the coin handler. The bill recycler is also adapted to alter the first information to include information relating to quantities of denomination(s) of bills available for dispensing by the bill recycler. The bill recycler is further adapted to send the altered first information to the vending machine controller.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 presents a block diagram of a vending machine;

FIG. 2 presents a block diagram of a vending machine according to embodiments of the present disclosure;

FIG. 3 presents a block diagram of a bill recycler according to embodiments of the present disclosure;

FIG. 4 presents a simplified block diagram of a controller according to embodiments of the present disclosure; and

FIG. 5 presents a method for operation of a bill recycler according to embodiments of the present disclosure; and

FIG. 6 presents a block diagram of another vending machine according to embodiments of the present disclosure.

### DETAILED DESCRIPTION

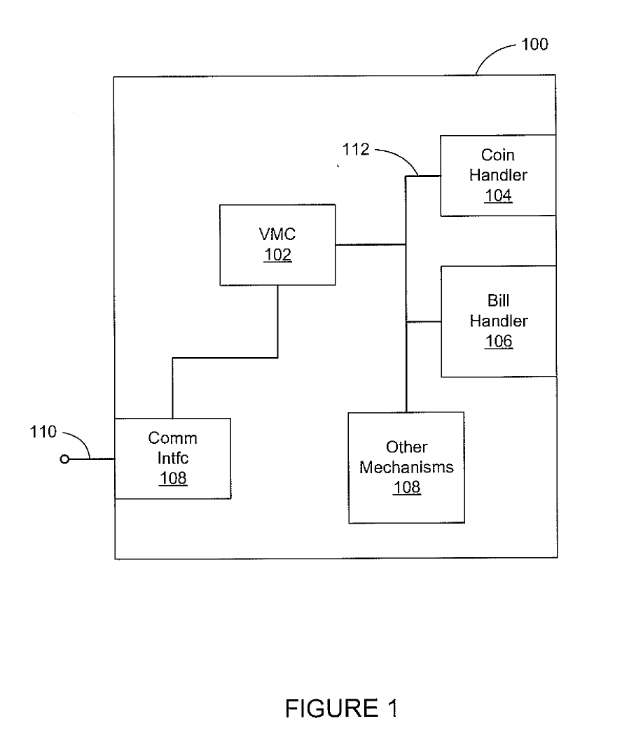

FIGS. 1 through 6, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged vending machine system.

Processes to monitor sales from a vending machine have been proposed or implemented. Such processes may provide accurate accounting of cash that should be returned and the products that are placed into the vending machines. One data exchange standard used by vending machines is the Data Exchange (DEX) protocol/interface. The DEX protocol provides fields for reporting bills and coupons stacked in a bill collection holding area (which may be referred to as “the bill box”) and for reporting coins and tokens sent to a coin collection holding area (which may be referred to as “the coin box”). Typically, the bill box and the coin box are separate mechanisms.

When a vending machine accepts bills of larger denominations, dispensing coins as change is problematic. For example, $5 bills, $10 bills and $20 bills may be accepted for products typically priced from $0.50 to $3. In some vending machines, still higher prices may be charged for specialty products such as plated food, cameras, and audio devices. In such circumstances, consumers may prefer to receive bills as change, rather than a “handful” of coins. Thus, receiving change in coins after inserting a $10 or $20 bill may be a deterrent to consumers who are considering making a purchase from such a vending machine.

Additionally, where coins are dispensed as change for products purchased using higher denomination bills, large numbers of coins may be dispensed as change, quickly depleting the number of coins available as change in a particular vending machine. As a result, vending machine operators may be required to replenish the supply of coins in such machines more frequently, which may result in higher labor costs and more extensive data tracking requirements.

One solution to this problem is the use of recycling bill validators. Such devices are capable of accepting bills with a range of values and subsequently dispensing some or all of the bills as change. Recycling bill validators may also enable a vending machine to return bills to a consumer in the event of the consumer cancelling a transaction.

When bill validators were added to existing vending machines, however, problems arose in accounting for the bills dispensed as change. Methods to support cash accountability have been developed that read the DEX stream of a vending machine and alter the DEX information to reflect bills that remained in the bill validator, rather than being stacked in the bill box. These alterations, in turn, were combined in the vending machine owner's vending management software to correctly reflect the quantities of bills that should be expected in the bill box.

New methods for reporting DEX information have also been developed. Such methods eliminate the need for intercepting DEX and provide the changes to accounting for recycled bills. However, utilizing these methods requires reprogramming the vending machines and changing the way the payment systems (for example, the coin handler and the bill validators/recyclers) communicate within the machine. The dominant protocol for communication within vending machines is the Multi-Drop Bus (MDB) protocol/interface. New standards have been devised to allow bill recycling.

There is a large installed base of existing vending machines, and such machines are capital assets of their owners. The owners, naturally, desire to maximize the lifetime of the machines and their period of use in commerce. With proper maintenance, a vending machine may be expected to operate for fifteen years or more. Thus, a major disadvantage to adopting new standards is the scope of changes needed to implement such standards in legacy vending machines or vending management software.

Vending machines controllers must be reprogrammed to employ such new methods and protocols. Because there is a large variety of vending machines in current use or production, implementation of the DEX changes is difficult, expensive, and time consuming to design, execute, test and deploy. Furthermore, it is unlikely that machines for which production has been discontinued by their manufacturer, but which are still operating successfully and have significant remaining operating life, will have their control system appropriately modified by the manufacturer to support the requisite changes.

Such disadvantages are also present for vending management software. Such software will need reprogramming to implement the changes required for dispensing bills as change, when such capability was not previously implemented. Vending management software is typically complex, and includes specialized hand held terminals for field data collection, driver input, numerous data bases. Vending management software may produce hundreds of reports. Reprogramming such software is costly and time-consuming.

FIG. 1 illustrates a vending machine 100 that includes a coin handler 104 and a bill handler 106. The coin handler 104 receives, validates, stores, and dispenses coins of one or more denominations. The bill handler 106 receives, validates, and stores bills of one or more denominations. Both the coin handler 104 and the bill handler 106 communicate with a vending machine controller (VMC) 102 via a communication link 112. The communication link 112 may use the vending industry standard multi-drop bus (MDB) protocol or other suitable communication protocol. The VMC 102 may also communicate with other mechanisms 108 via the communication link 112 to control the vending functions of the vending machine 100. The other mechanisms 108 may include credit card or debit card systems.

Using the communication link 112:
the VMC 102 may exchange setup and configuration messages with the coin handler 104 and the bill handler 106;
the coin handler 104 may send messages to the VMC 102 indicating a number and denomination of coins received from a consumer;
the bill handler 106 may send messages to the VMC 102 indicating a number and denomination of bills received from a consumer; and
the VMC 102 may send messages to cause the coin handler 104 to dispense a specified number of coins of specified denomination(s) as change.
   It will be understood that this list is not exhaustive, and that other messages may be exchanged between the VMC 102 and the coin handler 104 and the bill handler 106 via the communication link 112.

Based upon such messages, the VMC 102 typically maintains an inventory of the numbers and denominations of coins present in the coin handler 104 and numbers and denominations of bills present in the bill handler 106. This inventory may be used for auditing sales made by the vending machine 100, for determining when to schedule a service call to the location of the vending machine 100 (i) to replenish the inventory of coins in the coin handler 104, (ii) to remove bills from the bill handler 106, and (iii) to replenish the inventory of products in the vending machine. Such messages may also be used to detect abnormal machine conditions requiring repair.

The VMC 102 is also communicatively coupled to a communication interface 108. The VMC 102 uses the communication interface 108 to communicate product inventory, maintenance status, coin/bill inventory, auditing, and other information to an operator via an external communication link 110. The communication link 110 may be a wired link or a wireless link. Where the communication link 110 is a wireless link, it may employ infrared or radio frequency communication (such as Bluetooth, WiFi, and cellular). The communication link 110 may be a combination of wired and wireless communication links, where the VMC 102 communicates with certain external devices via a wired link and other external devices via a wireless link.

During a setup phase in the MDB protocol, the VMC 102 receives one or more messages from the coin handler 104 specifying the denominations of coin tubes in the coin handler 104 and the number of coins in each of the coin tubes. During operation, the VMC 102 may receive one or more messages from the coin handler 104 indicating numbers of coins received into one or more coin tubes from consumers. The VMC 102 may also send one or more messages to the coin handler 104 to dispense coins from the coin tubes as change.

In a first format for such dispense messages, the message instructs the coin handler 104 to dispense a single coin of a specified denomination. When using this first format, the VMC 102 may issue a series of messages to cause the coin handler 104 to dispense, in the aggregate, a desired total value of coins in change. In a second format, a single dispense message specifies a desired total value of coins for the coin handler 104 to dispense as change. In response, the coin handler 104 determines a combination of numbers and denominations of available coins that totals the specified value, dispenses the determined combination of coins, and sends one or more messages to the VMC 102 specifying the numbers and denominations of coins dispensed.

Thus, the VMC 102 has information relating to numbers and denominations of coins initially present in the coin handler 104, numbers and denominations of coins received into the coin handler 104, and numbers and denominations of coins dispensed by the coin handler 104. Based upon such information, the VMC 102 can account for all coins handled by the coin handler 104 and provide such auditing information to an external device via the communication interface 108 and the communication link 110.

Also during the setup phase in the MDB protocol, the VMC 102 may receive one or more messages from the bill handler 106 specifying the numbers and denominations of bills stored therein. During operation, the VMC 102 may receive one or more messages from the bill handler 106 indicating numbers and denominations of bills received from consumers and stored in the bill handler 106. The MDB protocol does not define messages by which the VMC 102 may instruct the bill handler 106 to dispense a bill as change.

Thus, the VMC 102 has information relating to numbers and denominations of bills initially present in the bill handler 106, and numbers and denominations of bills received into the bill handler 106. Based upon such information, the VMC 102 can account for all bills handled by the bill handler 106 and provide such auditing information to an external device via the communication interface 108 and the communication link 110.

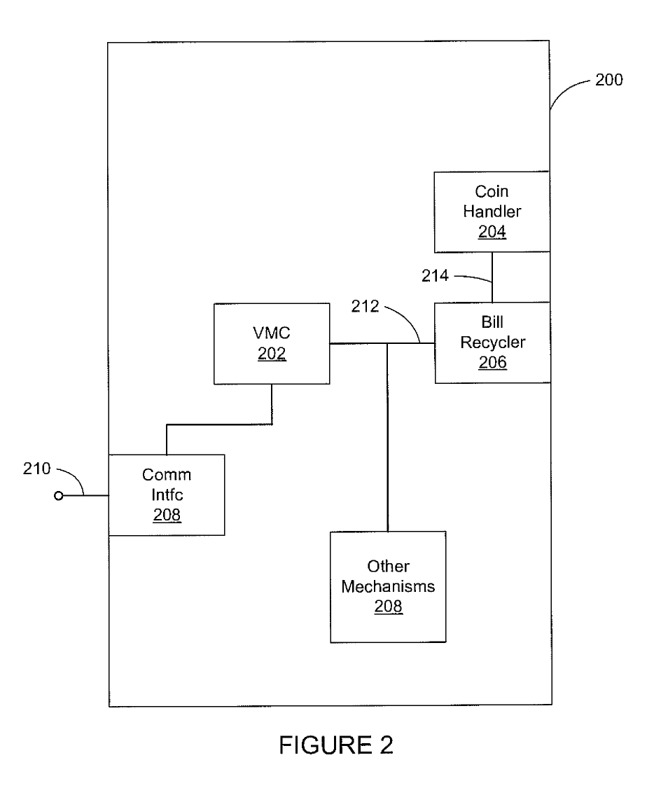

FIG. 2 illustrates a vending machine 200 that is one embodiment of the present disclosure. The vending machine 200 includes a coin handler 204 and a bill recycler 206. A vending machine controller (VMC) 202 communicates with the bill recycler 206 via a communication link 212, which may employ the MDB protocol or another suitable protocol. The VMC 202 also communicates with other mechanisms 208 via the communication link 212, in order to control vending and other functions of the vending machine 200. The VMC 202 is further communicatively coupled to a communication interface 208 and communicates through the communication interface 208 to external devices via an external communication link 210.

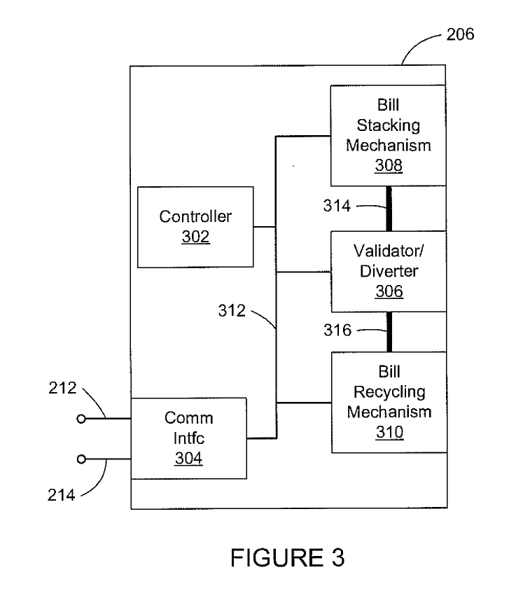

The coin handler 204 receives, validates, stores, and dispenses coins of one or more denominations. The bill recycler 206 receives, validates, stores and dispenses bills of one or more denominations. As is described in more detail with reference to FIG. 3, the bill recycler 206 includes a bill stacking mechanism (or other bill collection holding container) that stores bills that will not be dispensed as change. The bill recycler 206 also includes a bill recycling mechanism that stores bills of one or more denominations and is operable to dispense bills of a specified number and denomination as change.

The bill recycler 206 communicates with the coin handler 204 via a communication link 214. The communication link 214 preferably employs the same communication protocol employed in the communication link 212. In this way, where the vending machine 200 is a previously installed machine, the bill recycler 206 may be added to the vending machine 200 without the requirement that hardware or firmware/software changes be made to the VMC 202, the communications interface 208 or the coin handler 204.

Absent changes to the firmware/software, the VMC 202 is operable to exchange messages with a coin handler and a bill validator/stacker, such as the coin handler 104 and the bill handler 106 of FIG. 1. The bill recycler 206 receives messages sent by the VMC 202 to the coin handler and the bill validator/stacker. The bill recycler 206 also sends messages to the VMC 202, to provide responses that the VMC 202 expects to receive from the coin handler and the bill validator/stacker. Certain messages and responses are handled entirely within the bill recycler 206. Other messages and responses are handled by the coin handler 204, where the bill recycler 206 operates as either a conduit or a store-and-forward device for such messages and responses.

In some vending machines the VMC 202 and/or the coin handler 204 may expect to receive certain messages on a predetermined schedule—that is, with a predetermined maximum time between messages. Where the bill recycler 206 is substituting its own messages for those of the VMC 202 or the coin handler 204, it may ensure that its own messages are sent to a recipient on a schedule that meets the expectation of the recipient, in order to maintain proper operation of the vending machine 200.

In some vending machines the VMC 202 and/or the coin handler 204 may expect to receive a response to a message within a certain time period, or else an error is reported. Where the bill recycler 206 is intercepting and responding to such a message, for example sent by the VMC 202 to the coin handler 204, the bill recycler 206 may report information previously obtained from the coin handler 204, in order to meet the timing requirement of the VMC 202.

Where the bill recycler 206 is receiving a polling message from the VMC 202 for the coin handler 204 on a periodic basis, the bill recycler 206 may also poll the coin handler 204 on a periodic basis. In some embodiments, the bill recycler 206 may poll the coin handler 204 more frequently than the polling messages from the VMC 202 are received.

In other embodiments, the bill recycler 206 may poll the coin handler 204 immediately prior to the expected reception of a polling message from the VMC 202—that is, in anticipation of the polling message. That is, polls to the coin handler 204 may be sent by the bill recycler 206 at the same frequency as they are received from the VMC 202. The poll “dwell time” (or delay) may be tuned by the bill recycler 206 to get a response from the coin handler 204 just before the regular poll from the VMC 202 is expected to arrive.

Either technique (more frequent polling or polling in anticipation) provides the bill recycler 206 with “fresh” information from the coin handler 204 to include in a response to the VMC 202. The bill recycler 206 may adopt a similar strategy for handling such intercepted polling messages sent by the coin handler 204 to the VMC 202.

FIG. 3 presents a bill recycler 206 according to the present disclosure. The bill recycler includes a validator/diverter 306 that receives a bill inserted by a consumer. The validator/diverter 306 performs one or more tests on the bill to determine the validity, denomination and physical quality of the bill. If the bill is determined not to be valid, then the validator/diverter 306 returns the bill to the consumer. If the bill is determined to be a valid bill, the validator/diverter 306 communicates the denomination and physical quality of the bill to a controller 302 via a communication link 312. In response, if the bill is (i) of a denomination recycled by the bill recycler 206 and (ii) of adequate physical quality to be recycled successfully, the controller 302 instructs the validator/diverter 306 to divert the bill to a bill recycling mechanism 310. If the bill is (i) not of a denomination recycled by the bill recycler 206 or (ii) not of adequate physical quality to be recycled successfully, the controller 302 instructs the validator/diverter 306 to divert the bill to a bill stacking mechanism 308 (or other bill collection holding container).

The validator/diverter 306 is mechanically coupled to the bill stacking mechanism 308 via a chute or aligned openings 314 and to the bill recycling mechanism 310 via a chute or aligned openings 316. The chute 314 and the chute 316 operate to physically convey bills from the validator/diverter 306, respectively, to the bill stacking mechanism 308 and the bill recycling mechanism 310.

The bill stacking mechanism 308 is communicatively coupled to the controller 302 by the communication link 312. Communication over the link 312 typically comprises the controller 302 actively operating motors/actuators of the bill stacking mechanism 308 while observing sensors that track the operation of the bill stacking mechanism 308. In other embodiments, communication over the link 312 may be between separate microprocessors in the controller 302 and the bill stacking mechanism 308. In either embodiment, the bill stacking mechanism 308 may be operable to send a message to the controller 302 to indicate that a bill has been received from the validator/diverter 306.

The bill recycling mechanism 310 is also communicatively coupled to the controller 302 by the communication link 312. Communication over the link 312 typically comprises the controller 302 actively operating motors/actuators of the bill recycling mechanism 310 while observing sensors that track the operation of the bill stacking mechanism 308. In other embodiments, Communication over the link 312 may be between separate microprocessors in the controller 302 and the bill recycling mechanism 310. In either embodiment, the bill recycling mechanism 310 may be operable to send a message to the controller 302 to indicate that a bill has been received from the validator/diverter 306.

The bill recycling mechanism 310 is also operable to receive a message from the controller 302 instructing the bill recycling mechanism 310 to dispense a bill and, where the bill recycling mechanism 310 holds bills of several denominations, indicating a denomination of the bill to be dispensed. In some embodiments, the bill recycling mechanism 310 conveys the bill to the validator/diverter 306 via the chute 316, whereupon the validator/diverter 306 dispenses the bill. In other embodiments, the bill recycling mechanism 310 has a separate outlet by which it directly dispenses the bill.

The controller 302 is communicatively coupled via the communication link 312 to a communication interface 304. The communication interface 304 is, in turn, communicatively coupled to the communication link 212 of FIG. 2 and the communication link 214 of FIG. 2. In this way, the controller 302 is able to communicate with the controller 202 of FIG. 2 via the communication link 212 and with the coin handler 204 of FIG. 2 via the communication link 214.

During a configuration phase, the controller 302 receives one or more MDB configuration messages from the coin handler 204 via the communication link 214. The configuration messages include information that identifies coin tubes that are present in the coin handler 204, a denomination of each coin tube, and a number of coins in each coin tube. The controller 302 may augment these configuration messages by including information representing one or more “virtual coin tubes,” each associated with a denomination of bills available for dispensing in the bill recycling mechanism 310.

When the VMC 202 sends a message requesting configuration information from the coin handler 204 via the communication link 212, the controller 302 responds with an augmented message. In this way, without changes to the firmware/software of the VMC 202, the bill recycler 206 is operable to report both coins available for dispensing from the coin handler 204 and bills available for dispensing from the bill recycler 206.

In some circumstances, the coin handler 204 accepts coins of a same denomination as bills recycled by the bill recycling mechanism 310—for example, one dollar coins and one dollar bills. In such situations, the bill recycler 206 is operable to combine the number of one dollar coins available for dispensing from the coin handler 204 with the number of one dollar bills available for dispensing from the bill recycler 206. The bill recycler 206 then reports this combined quantity as the quantity of “coins” in the one dollar coin tube in the augmented configuration information response message to the VMC 202. Subsequently, whether a one dollar coin is dispensed from the coin handler 204 or a one dollar bill is dispensed from the bill recycling mechanism 310, the bill recycler is operable to report to the VMC 202 that a “coin” has been dispensed from the one dollar coin tube.

The bill recycler 206 reports bills stored in the bill stacking mechanism 308 using MDB messages developed for communicating with bill handlers such as the bill handler 106 of FIG. 1. In this way, the VMC 202 is able to account for and report currency in all three repositories of the vending machine 200: the coin handler 204, the bill stacking mechanism 308, and the bill recycling mechanism 310.

When required to dispense change from a transaction, the VMC 202 sends a message to the coin handler 204 instructing it to dispense change. Because the configuration messages sent to the VMC 202 by the bill recycler 206 included both actual coin tubes in the coin handler 204 and “virtual coin tubes” in the bill recycling mechanism 310, the change dispensing messages sent by the VMC 202 may instruct dispensing from either actual or virtual coin tubes.

Where the controller 302 receives a change dispensing message in a format that instructs the coin handler 204 to dispense a single coin of a specified denomination, the controller 302 may respond in either of two ways. In a first response, the controller 302 may determine whether the specified denomination is in an actual coin tube in the coin handler 204 and resend the message to the coin handler 204 via the communication link 214. Such a response may be suitable where the VMC 202 is operable to instruct the dispensing of money from any of the coin tubes, both actual and virtual.

A second response may be appropriate where the VMC 202 is operable only to instruct the dispensing of money from coin denominations—that is, only coins from the actual coin tubes of the coin changer 204. In this circumstance, the controller 302 may accumulate change dispensing messages until the total amount to be dispensed equals the value of a bill in the bill recycling mechanism 310. In response, the controller 302 may then instruct the bill recycling mechanism 310 to dispense a bill of that denomination. If change dispensing messages totaling less than the value of a bill have been accumulated and a predetermined amount of time passes without receiving a further change dispensing message, the controller 302 may send the accumulated change dispensing messages unaltered to the coin handler 204 via the communication link 214. Upon receipt of the accumulated messages, the coin handler 204 dispenses coins as instructed in the messages.

Where the controller 302 receives a change dispensing message in a format that instructs dispensation of a total value of change, the controller 302 may dispense as much of the total value as may be dispensed in bills. The controller 302 then changes the total value to be dispensed to reflect the remaining, undispensed value and sends a change dispensing message with the changed amount to the coin handler 204 to be dispensed in coins.

Where the controller 302 is instructing both the coin handler 204 and the bill recycling mechanism 310 to dispense change, the controller 302 may issue dispensing instructions to the coin handler 204 and the bill recycling mechanism 310 at different times. This may be done to prevent both mechanisms from being active at the same time, where such simultaneous activity would require more power than a power supply of the vending machine 200 is capable of providing safely or without malfunction.

Regardless of the format of change dispensing message received, after responding to the message by dispensing currency, the controller 302 may report to the VMC 202 the numbers of coins (and “virtual coins”) dispensed from one or more coin tubes, both actual and virtual. Additionally, the controller 302 may report to the VMC 202 both coins and bills dispensed from coin tubes of a denomination dispensed by both the coin handler 204 and the bill recycling mechanism 310.

Where bills are manually dispensed by service personnel from the bill recycling mechanism 310, the controller 302 may report such bills to the VMC 202 as “virtual coins” dispensed from the corresponding “virtual coin tubes.” Similarly, bills manually inserted into the bill recycling mechanism 310 by service personnel may be reported to the VMC 202 as “virtual coins” deposited into the corresponding “virtual coin tubes.”

In this way, the VMC 202 is operable to control and audit the coin handler 204 and the bill recycler 206 without changes to the hardware or firmware/software of either the coin handler 204 or the VMC 202.

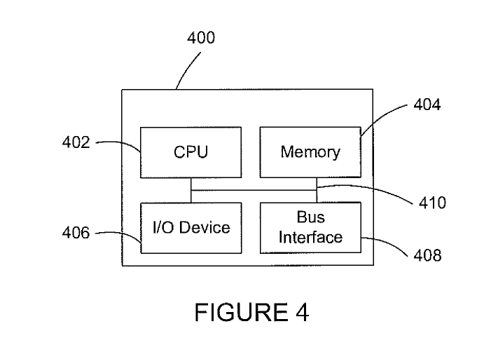

FIG. 4 presents a simplified block diagram of a controller 400 according to embodiments of the present disclosure. Either or both of the VMC 202 of FIG. 2 and the controller 302 of FIG. 3 may be implemented using the controller 400. The embodiment of the controller 400 shown in FIG. 4 is for illustration only. Other embodiments of the controller 400 may be used without departing from the scope of this disclosure.

The controller 400 includes a central processing unit (“CPU”) 402, a memory unit 404, one or more input/output (“I/O”) devices 406, and a bus interface 408. The bus interface 408 couples the controller 400 to the communication link 212, in the case of the VMC 202, or to the communication link 312, in the case of the controller 302. The components 402, 404, 406, and 408 are interconnected by one or more communication links 410 (e.g., a bus). It is understood that the controller 400 may be differently configured and that each of the listed components may actually represent several different components. For example, the CPU 402 may actually represent a multi-processor or a distributed processing system; the memory unit 404 may include different levels of cache memory, main memory, hard disks, and remote storage locations; and the I/O device 406 may include a display, touch screen, and the like. Alternatively, single components may be utilized for two or more of the components illustrated.

Memory unit 404 includes programming instructions adapted to be utilized by the CPU 402 to direct the components of the vending machine 200 or the bill recycler 206 through procedures and operations as described herein. Memory unit 404 is further adapted to store program code for execution by the CPU 402, as well as volatile and non-volatile data for use by the CPU 402.

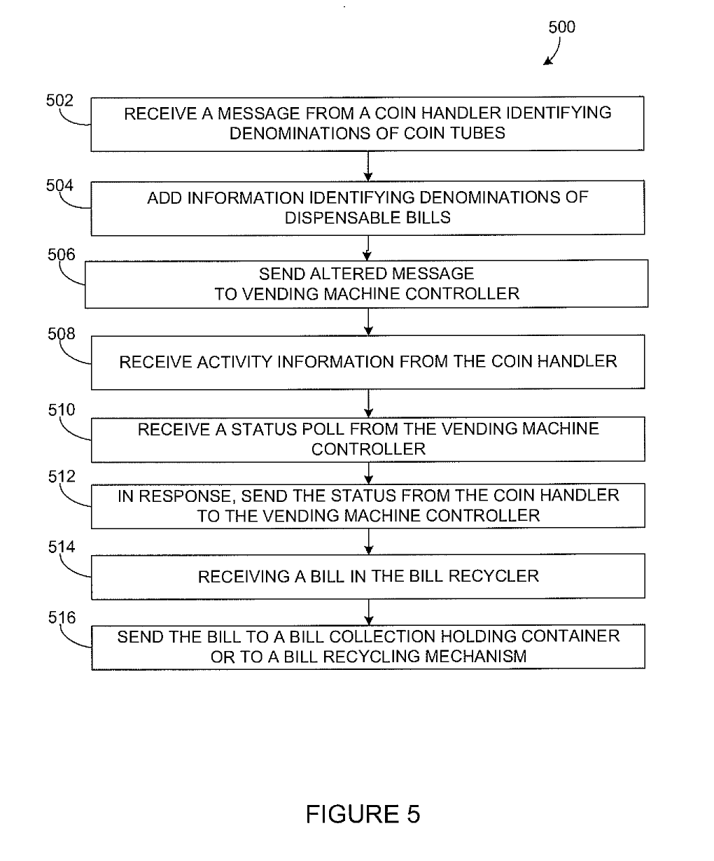

FIG. 5 presents a method 500 for operation of a bill recycler according to embodiments of the present disclosure. For clarity of explanation, references are made to elements of FIGS. 2 and 3 in describing the method 500.

In step 502, the bill recycler 206 receives an MDB configuration message from the coin handler 204. The configuration message includes information that identifies coin tubes that are present in the coin handler 204 and a denomination of each coin tube. In step 504, the bill recycler 206 adds “virtual” coin tubes to the received information, representing denominations of bills dispensed by the bill recycler 206. In step 506, the bill recycler 206 sends an MDB configuration message to the VMC 202 that includes the coin tube information received from the coin handler 204, as altered by the bill recycler 206.

In step 508, the bill recycler 206 receives a message including activity information from the coin handler 204. Such activity may include information related to coins received and/or coins dispensed by the coin handler 204. The message received in step 508 is typically sent by the coin handler 204 in response to a poll message sent to the coin handler 204 by the bill recycler 206. In step 510, the bill recycler 206 receives a poll message from the VMC 202, requesting activity information from the coin handler 204. In step 512, the bill recycler 206 responds by sending the activity information received from the coin handler 204 in step 508 to the VMC 202.

In step 514, the bill recycler 206 receives a bill inserted by a consumer or vending machine technician. The bill recycler 206 performs one or more tests on the bill to determine the denomination and physical quality of the bill. In step 516, according to results of the tests, the bill recycler 206 sends the bill either to the bill stacking mechanism 308 or to the bill recycling mechanism 310. If the bill is (i) not of a denomination recycled by the bill recycler 206 or (ii) not of adequate physical quality to be recycled successfully, the bill recycler 206 sends the bill to the bill stacking mechanism 308 (or other bill collection holding container). If the bill is (i) of a denomination recycled by the bill recycler 206 and (ii) of adequate physical quality to be recycled successfully, the bill recycler 206 sends the bill to the bill recycling mechanism 310.

The steps 502 through 506 of the method 500 are typically performed when the vending machine 200 is powered up. However, the group of steps 508 through 512 are typically performed independently of the group of steps 514 through 516, and the two groups of steps may be performed in any order and any number of times, relative to each other.

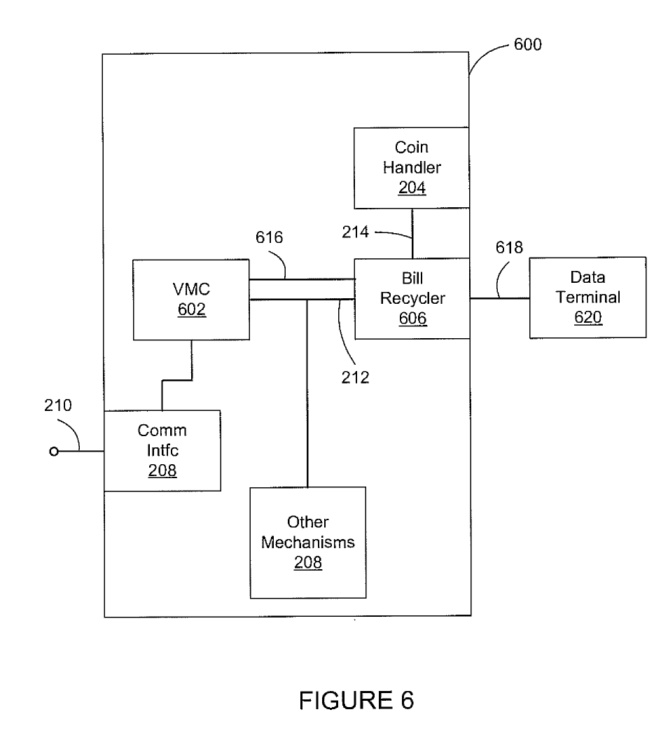

FIG. 6 presents a block diagram of another vending machine 600 according to embodiments of the present disclosure. The vending machine 600 includes a coin handler 204 and a bill recycler 606. A vending machine controller (VMC) 602 communicates with the bill recycler 606 via a communication link 612. The communication link 212 may employ the MDB protocol or other suitable protocol on the communication link 212. The VMC 602 also communicates with other mechanisms 208 via the communication link 212, in order to control vending and other functions of the vending machine 600. The VMC 602 is further communicatively coupled to a communication interface 208 and communicates through the communication interface 208 to external devices via an external communication link 210.

The VMC 602 is also coupled to the bill recycler 606 via a communication link 616. The bill recycler 606 is configured to exchange messages with the VMC 602 using the DEX protocol on the communication link 616. The bill recycler 606 is further coupled to a data terminal 620 by a communication link 618. The bill recycler 606 is configured to exchange messages with the data terminal 620 using the DEX protocol on the communication link 618.

The data terminal 620 may be used by vending machine operators to gather information from the vending machine 600 for use in audit functions of vending management software. The bill recycler receives DEX messages from the VMC 602 that include information relating to bills stacked in a bill collection holding area and coins sent to a coin collection holding area or coin changer. The bill recycler 606 adds further information relating to bills held in the bill recycler 606 for dispensing as change. The combined information is then sent to the data terminal 620 using DEX messages. In this way, the vending machine operator's vending management software is able to correctly account for all coins and bills contained in the vending machine 600.

In other embodiments, the communication link 618 may use a wireless technology such as Bluetooth or infrared for communication between the bill recycler 606 and the data terminal 620. In still other embodiments, the communication link 618 may use a wide-area network, the Internet, or cellular communication technology to communicate to the data terminal 620 or directly to a central server of the vending machine operator's vending management software.

It may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. The term “controller” means any device, system, or part thereof that controls at least one operation. A controller may be implemented in hardware, firmware, software, or some combination of at least two of the same. The functionality associated with any particular controller may be centralized or distributed, whether locally or remotely.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method of dispensing bills as change in a vending machine, the method comprising:
receiving in a bill recycler a first message, the first message intended for a first device and the first message including first information, wherein the first information relates to one or more denominations of coins available for dispensing by the coin handler;
altering the first information in the bill recycler to include second information relating to one or more denominations of bills available for dispensing by the bill recycler;
sending the altered first information to the first device;
receiving in the bill recycler third information from the coin handler;
receiving in the bill recycler a third message, requesting the third information from the coin handler; and
sending a response to the third message, the response including the third information.

2. The method of claim 1, wherein the bill recycler receives a plurality of third messages on a first periodic basis and receives the third information in response to a fourth message, the method further comprising sending the fourth message on a second periodic basis, where the second period is based on the first period.

3. The method of claim 2, wherein the second period is shorter than the first period.

4. The method of claim 2, wherein the second period is substantially the same as the first period and the fourth message is sent at a time selected to reduce a time period between receiving the third information and receiving the third message.

5. The method of claim 1, further comprising:
receiving a bill in the bill recycler; and
one of sending the bill to a bill collection holding container and sending the bill to a bill recycling mechanism.

6. The method of claim 5, further comprising:
determining in the bill recycler a physical quality of the bill; and
sending the bill to the bill collection holding container if the bill is determined not to be of adequate physical quality to be recycled successfully.

7. The method of claim 5, further comprising:
determining in the bill recycler a denomination of the bill; and
sending the bill to the bill recycling mechanism based on the denomination of the bill.

8. A bill recycler for use in a vending machine, the bill recycler comprising:
a controller; and
a bill recycling mechanism,
wherein the controller is adapted to:
receive a first message, the first message intended for a first device and the first message including first information, wherein the first information relates to one or more denominations of coins available for dispensing by the coin handler;
alter the first information to include information relating to quantities of one or more denominations of bills available for dispensing by the bill recycler; and
send the altered first information to the first device.

9. The bill recycler of claim 8, wherein the controller is further adapted to alter the first information by adding the quantity of the bills to the quantity of the coin.

10. The bill recycler of claim 8, wherein the controller is further adapted to alter the first information by adding second information to the first information, the second information relating to the denominations of the bills and the quantities of the bills.

11. The bill recycler of claim 8, wherein the controller is further adapted to:
receive a second message, the second message including third information relating to a denomination of a coin to be dispensed; and
in response to the second message, dispense a bill from the bill recycling mechanism in lieu of the coin.

12. The bill recycler of claim 11, wherein the controller is further adapted to:
receive a plurality of instances of the second message; and
dispense the bill from the bill recycling mechanism when a total value of the coins to be dispensed according to the received plurality of second messages equals the value of the bill.

13. The bill recycler of claim 8, wherein the controller is further adapted to:
receive a third message, the third message including fourth information relating to a total value of change to be dispensed;
in response to the third message, dispense a bill from the bill recycling mechanism.

14. The bill recycler of claim 13, wherein the controller is further adapted to:
alter the fourth information by reducing the total value by the value of the bill dispensed; and
send the altered fourth information to the coin handler.

15. A vending machine, comprising:
a vending machine controller;
a bill recycler; and
a coin handler,
wherein the bill recycler is adapted to:
receive from the coin handler a first message, the first message including first information, wherein the first information relates to one or more denominations of coins available for dispensing by the coin handler;
alter the first information to include information relating to a quantities of one or more denominations of bills available for dispensing by the bill recycler; and
send the altered first information to the vending machine controller.

16. The vending machine of claim 15, wherein the bill recycler is further adapted to alter the first information by adding the quantity of the bills to the quantity of the coins.

17. The vending machine of claim 15, wherein the bill recycler is further adapted to alter the first information by adding second information to the first information, the second information relating to the denominations of the bills and the quantities of the bills.

18. The vending machine of claim 15, wherein the bill recycler is further adapted to:
receive a second message, the second message including third information relating to a denomination of a coin to be dispensed; and
in response to the second message, dispense a bill.

19. The vending machine of claim 18, wherein the bill recycler is further adapted to:
receive a plurality of instances of the second message; and
dispense the bill when a total value of coins to be dispensed according to the received plurality of second messages equals the value of the bill.

20. The vending machine of claim 15, wherein the bill recycler is further adapted to:
receive a third message, the third message including fourth information relating to a total value of change to be dispensed;
in response to the third message, dispense a bill.

21. The vending machine of claim 20, wherein the bill recycler is further adapted to:
alter the fourth information by reducing the total value by the value of the bill dispensed; and
send the altered fourth information to the coin handler.
